(19) United States
(12) Patent Application Publication
(10) Pub. No.: US 2006/0180281 A1
(43) Pub. Date: Aug. 17, 2006

(54) Apparatus to suspend garage door drives

(76) Inventor: Michael Hoermann, Oerlinghausen (DE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/218,083

(22) Filed: Aug. 31, 2005

(30) Foreign Application Priority Data
Jan. 13, 2005 (DE) 20 2005 000 498.7

(51) Int. Cl. E06B 3/48

(52) U.S. Cl. 160/181

(57) ABSTRACT

The present invention relates to an apparatus to suspend garage door drives that are fitted with a drive unit and a guide rail, preferably a C-shaped guide rail. The apparatus typically includes a rail with assembly holes and a clamp to engage around the guide rail. The rail has respective plate-like widened sections at the sides which carry folded prolongations at diagonally opposite end edges which can engage around the guide rail like a clamp.

### CROSS REFERENCE TO RELATED APPLICATION

This application claims priority to German Patent Application Serial No. 20 2005 000498.7, filed Jan. 13, 2005, which is hereby incorporated by reference in its entirety for all purposes.

### FIELD

The present disclosure relates to an apparatus to suspend garage door drives, which are fitted with a drive unit and a guide rail, preferably a C-shaped guide rail.

### BACKGROUND AND SUMMARY

Garage door drives for garage doors to be opened automatically, for example sectional doors, usually have a drive motor arranged in a housing, and a guide rail fitted to this housing. The guide rails are as a rule made in a C shape and serve to guide a garage door drive, which is moved along the C-shaped guide rail by means of a drive chain driven by the motor, a drive belt, or the like. The garage door drives are usually mounted on the garage ceiling with the C guide rails using fastenings or clamps. Fastenings and clamps consisting of a plurality of individual parts are frequently assembled on site by the fitter. Since they are universally usable holed webs, they are only bent into the desired shape during the installation, and then adapted to the installation situation. This is time-consuming and complex.

An object of the present invention is to provide an apparatus to suspend garage door drives which is simple to mount and can be used universally.

This object may be satisfied by an apparatus in accordance with claim 1.

Accordingly, the apparatus to suspend garage door drives, fitted with a drive unit and a guide rail, preferably a C-shaped guide rail, includes a rail with assembly holes and a clamp to engage around the guide rail, with the rail in each case having plate-like widened profiles at the side, which carry folded prolongations at diagonally opposed longitudinal end edges and which can engage around the guide rail in the manner of a clamp. One particular advantage of this suspension apparatus is that it can be placed onto a guide rail of the door drive at an angle, and can be connected to the rail profile by turning in the clamp-like apparatus around the rail profile. For this purpose, the rail, which has respective assembly holes, is fitted with the plate-like widened sections, that carry folded prolongations which are diagonally offset from one another and engage around the C-shaped rail in the manner of a clamp. The angled placing of the apparatus is possible due to the diagonal arrangement, and the clamps engage around the profile of the guide rail after a corresponding rotation with respect to the guide rail. A secure fit is hereby ensured. The guide rail connected to the suspension apparatus in this manner can be mounted beneath the ceiling of a garage door, in that corresponding screws are inserted through the assembly holes provided in the suspension device.

Preferred aspects of the present invention are claimed in dependent claims. The suspension apparatus may advantageously be made in one piece from a metal sheet.

The prolongations can have two profiles, starting from the respective face edge of the plate-like widened section, which are folded at approximately a right angle to one another. A two-part clamp configuration is hereby achieved, which as previously stated, includes diagonally offset face edges. This permits the angled placing and the clamp connection by rotation of the suspension apparatus. The folded regions of the prolongations, which extend with parallel surfaces to the plate-like widened section, can each have a terminating edge chamfered at an angle α to the symmetrical line extending in the transverse direction, with the terminating edges of the diagonally opposing prolongations extending parallel to one another.

The angle α can be approximately 10-40°, but preferably is approximately 25°, so that a relatively slightly chamfered placing results here and only a small rotational movement is sufficient to fix the clamp-like suspension apparatus.

Corresponding bending lugs are particularly advantageously fitted in the region of at least one longitudinal end edge of the plate-like widened section, at which no prolongations adjoin. Generally, one bending lug is sufficient here. For a more secure connection, however, two diagonally opposite bending lugs are advantageously provided. These bending lugs permit a securing of the suspension apparatus placed on the guide rail, since otherwise the once-fixed suspension device could easily be unintentionally released by an unwanted rotational movement during the assembly.

### BRIEF DESCRIPTION OF THE FIGURES

Further features, details and advantages of the present invention will be explained in more detail with reference to an embodiment shown in the following figures.

FIG. 1 is a perspective view of a suspension apparatus in accordance with the present invention during assembly.

FIG. 2A is a top view of the suspension apparatus of FIG. 1.

FIG. 2B is a front view of the suspension apparatus of FIG. 1.

FIG. 2C is a bottom view of the suspension apparatus of FIG. 1.

FIG. 2D is a end view of the suspension apparatus of FIG. 1.

FIG. 2E is a perspective view of the suspension apparatus of FIG. 1.

FIG. 3A is an end view of a guide rail to which the suspension apparatus of FIG. 1 may be installed.

FIG. 3B is a side view of the guide rail of FIG. 3A, with the suspension apparatus of FIG. 1 partially installed at an angle thereon.

FIG. 3C is a side view of the guide rail of FIG. 3A, with the suspension apparatus of FIG. 1 rotated such that prolongations of the suspension apparatus contact and clamp the guide rail.

FIG. 3D is a side view of the guide rail of FIG. 3A, with the suspension apparatus positioned as shown in FIG. 3C, and further showing a bending lug of the suspension apparatus bent downward to secure the suspension apparatus to the guide rail.

FIG. 3E is a top, plan view of the guide rail of FIG. 3A.

FIG. 3F is a top, plan view of the guide rail and suspension apparatus in the configuration shown in FIG. 3B.

FIG. 3G is a top, plan view of the guide rail and suspension apparatus in the configuration shown in FIG. 3C.

FIG. 3H is a top, plan view of the guide rail and suspension apparatus in the the configuration shown in FIG. 3D.

### DETAILED DESCRIPTION

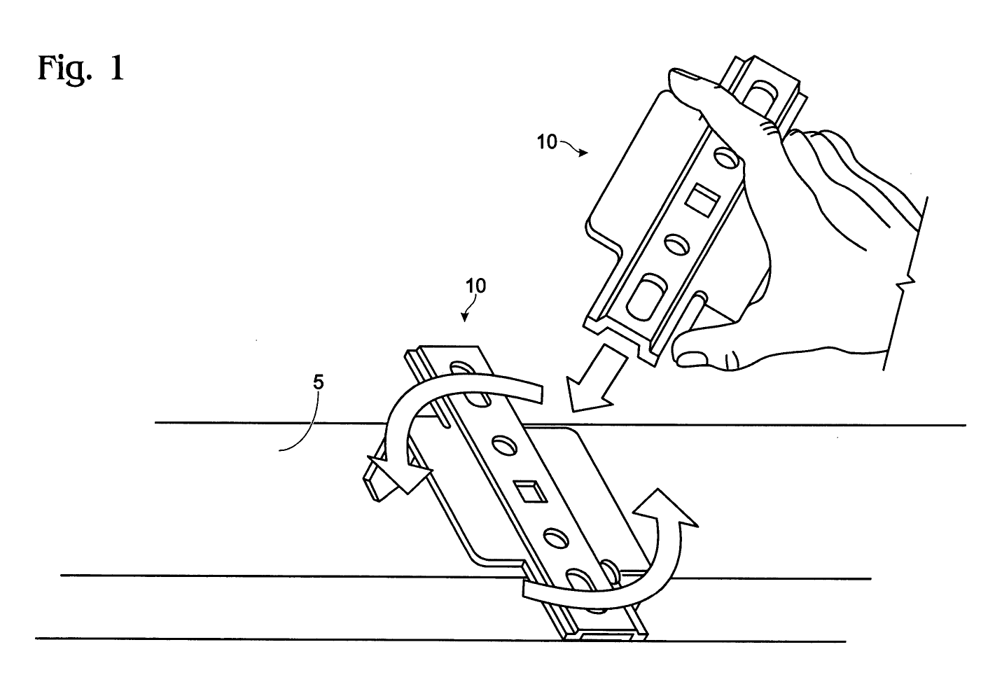

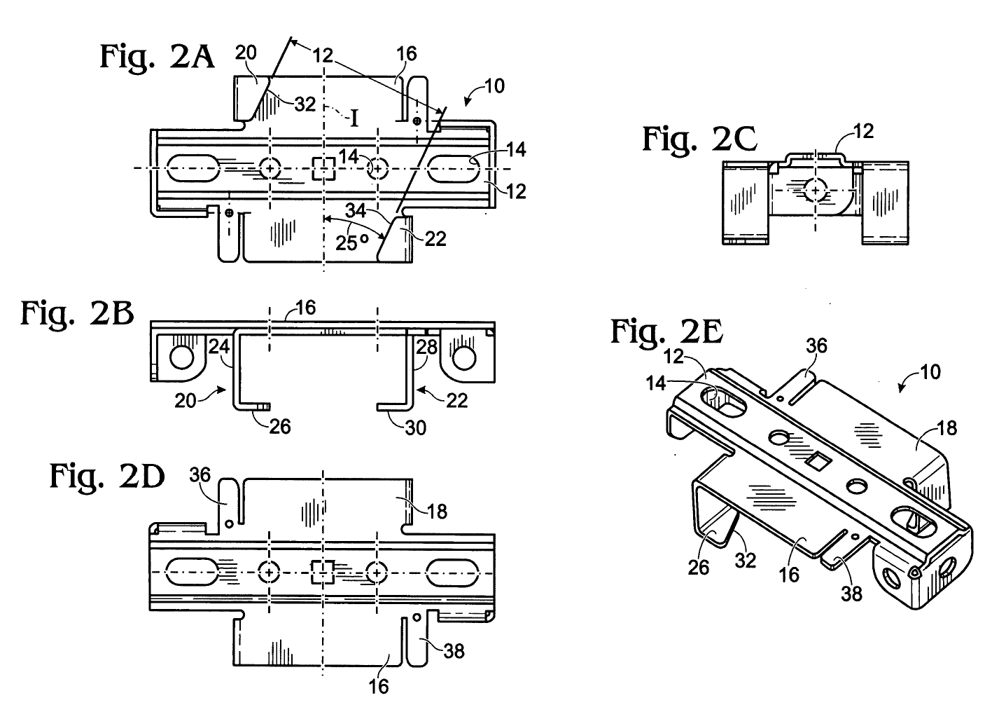

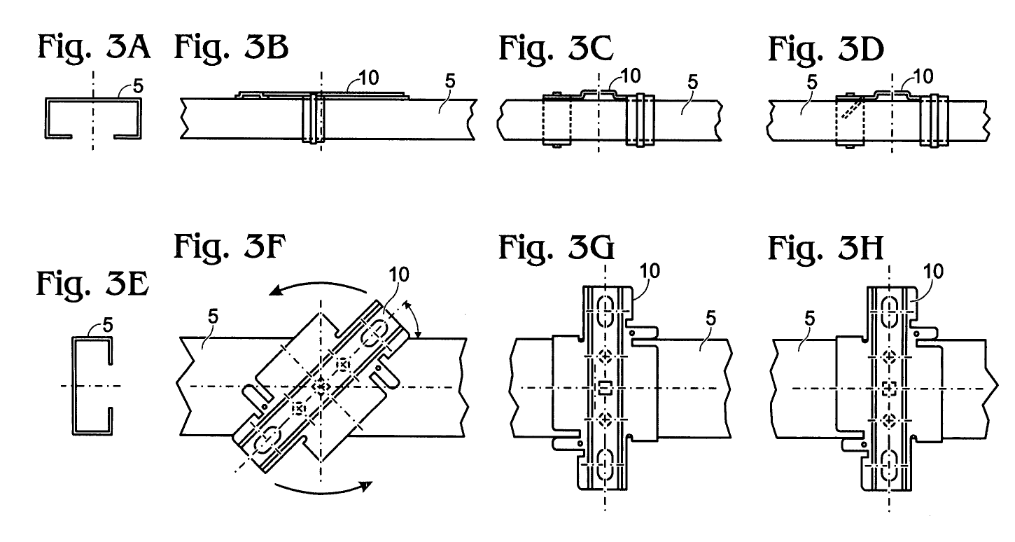

An apparatus to suspend garage door drives in accordance with one embodiment of the present invention can be seen in FIGS. 2A-2F. A central part of the suspension apparatus 10 is a rail 12 which has various assembly holes 14. As shown in FIG. 2A, these assembly holes can be made as simple bores or also as elongate holes. FIG. 2C in particular allows the recognition that the central rail 12 has a profile. The rail 12 has plate-like widened sections 16 and 18 at the sides. A contact surface is hereby defined. The plate-like widened sections 16 and 18 have a perimeter formed by a lateral side edge positioned opposite the rail 12 and a pair of longitudinal end edges formed at the longitudinal ends of the plate-like widened sections. Folded prolongations 20 and 22 are positioned at diagonally opposite longitudinal end edges. Each prolongation 20, 22 extends from a respective face edge of a plate-like widened sections 16, 18, and each prolongation 20, 22 has two sections, 24, 26 and 28, 30 respectively, which are each folded at right angles to one another. With this configuration, as can be seen from FIG. 2B, a clamp results. This clamp is dimensioned such that the suspension apparatus 10, as shown in FIG. 1, can engage around a C-shaped guide rail of a garage door drive (as shown in FIGS. 3B and 3D). End views of such a guide rail are shown in FIGS. 3A and 3E.

The folded regions of the prolongations 26 and 30, which extend with parallel surfaces to the plate-like widened section 16 or 18, each are formed symmetrically at an angle α relative to line of symmetry I (FIG. 2A) extending in the transverse direction, with, as can be seen from FIG. 2, the respective terminating edges 32 and 34 of the sections 20 and 22 extending parallel to one another. Typically, angle α is between approximately 10° and approximately 40°, and preferably angle α is 25°. As shown in FIGS. 3A-3H, it is hereby made possible for the suspension apparatus first to be placed onto the C-shaped guide rail at an angle and then rotated in the direction of the arrow in FIG. 3F, so that the sections 20 and 22 engage behind the C-shaped guide rail and thus connect the suspension apparatus to the guide rail. This placement and rotation mechanism is also shown in the perspective representation in accordance with FIG. 1 by the corresponding arrows. After the placement of the suspension apparatus, the line of symmetry I of the suspension apparatus extending in the transverse direction extends in the same direction as the line of symmetry of the guide rail. The suspension apparatus has bending lugs 36 and 38 at the longitudinal end edges of the plate-like widened sections 16 and 18. On these end edges, downwardly extending prolongations such as 20 and 22 are not included. These bending lugs 36 and 38 can be bent over in the manner shown in FIG. 3D so that they secure the suspension apparatus 10 on the guide rail 5 and prevent an unintentional turning back into the open position.

We claim:

1. An apparatus to suspend garage door drives that are fitted with a drive unit and a guide rail, the apparatus comprising:
a rail with assembly holes and a clamp to engage around the guide rail;
wherein the rail has respective plate-like widened sections at the sides which carry folded prolongations at diagonally opposite end edges, which are configured to engage around the guide rail to form the clamp.

2. The apparatus of claim 1, wherein the rail and clamp are shaped in one piece from a metal sheet.

3. The apparatus of claim 1, wherein each prolongation extends from a respective end edge of one of the plate-like widened sections, and further wherein each prolongation includes two sections which are folded approximately at a right angle to one another.

4. The apparatus of claim 3, wherein corresponding folded sections of the prolongations extend with parallel surfaces to the plate-like widened section, each have a terminating edge chamfered at an angle at to a symmetrical line extending in a transverse direction, and wherein the terminating edges extend parallel to one another.

5. The apparatus of claim 4, wherein the angle α is between approximately 10° and approximately 40°.

6. The apparatus of claim 5, wherein the angle α° is approximately 25°.

7. The apparatus of claim 1, wherein a bending lug is fitted to at least one of the plate-like widened sections in a region of an end edge to which no prolongation is adjoined.

8. The apparatus of claim 1, wherein a bending lug is fitted to each plate-like widened section in a region of an end edge to which no prolongation is adjoined.
